(19) United States
(12) Patent Application Publication
(10) Pub. No.: US 2005/0088723 A1
(43) Pub. Date: Apr. 28, 2005

(54) Waveguide optical amplifier

(75) Inventors: Hiroshi Kawazoe, Yokohama-shi (JP); Kenichi Muta, Yokohama-shi (JP)

Correspondence Address: TOWNSEND & BANTA;c/o PORTFOLIO IP, PO BOX 52050, MINNEAPOLIS, MN, 55402, US

(73) Assignees: Hiroshi Kawazoe; Moritex Corporation

(21) Appl. No.: 10/691,559

(22) Filed: Oct. 24, 2003

(51) Int. Cl. H01S 3/00

(52) U.S. Cl. 359/333

(57) ABSTRACT

The conventional EDFA has such problems that it is very costly since it requires an external high-energy laser diode and an optical coupling means for optically coupling the pumping light given from the laser diode, and that it must have a long length for obtaining a desired amplification degree. A constitution having an optical waveguide and an pumping light source integrated for solving the problems is also proposed, but it also has a problem in view of downsizing.

This invention proposes a waveguide optical amplifier 1, in which a surface light emission source 3 for pumping driven electrically is provided adjacently to and integrally with an optical waveguide 2 doped with a light-emitting species, in the longitudinal direction of the optical waveguide.

### FIELD OF THE INVENTION

The present invention relates to a waveguide optical amplifier applicable, for example, to an optical fiber communication system.

### BACKGROUND OF THE INVENTION

Recently high-speed broadband subscribers' networks such as ADSL, CATV and FTTH are widely used, and in this connection, it has become important to improve Metro Networks, for example, by enhancing their capacities. For the improvement of Metro Networks, it is urgently demanded that the optical amplifier used as a key device in the optical fiber communication system allows easier handling and is downsized.

As a typical conventional optical amplifier for a long-distance transmission line of an optical fiber communication system, an erbium-doped fiber amplifier (EDFA) is known.

Examples of known erbium-doped fiber amplifiers are disclosed in U.S. Pat. Nos. 5,271,024, No. 5,636,301 and No. 5,768,012 etc.

For example as shown in the conceptual view of FIG. 10, the EDFA is basically composed of an erbium-doped optical fiber b connected with an ordinary optical fiber a, an pumping light source c, and an optical coupling means d for optically coupling the pumping light given from the pumping light source c with the input light applied through the optical fiber a. The erbium-doped optical fiber b is a silica-based optical fiber doped with erbium (Er) as a rare earth element used as a light-emitting species and is a coil formed by winding the silica-based optical fiber with a length of several meters to tens of meters. As the pumping light source c, for example, a high-energy laser diode (LD) can be used.

In the EDFA composed as described above, the light from the pumping light source c pumpes the Er³⁺ in the erbium-doped optical fiber b, to repeat stimulated emission with the optical signal applied through the optical fiber a, for optical signal amplification.

The conventional EDFA as described above has the following problems confronting the above-mentioned demands.
1. As an pumping light source, an external high-energy laser diode is necessary, and an optical coupling means for optically coupling the pumping light given from the source is necessary, to raise the cost.
2. Since the erbium content of the erbium-doped optical fiber is relatively low, the length for obtaining the desired amplification degree becomes long.
3. The above-mentioned requirements 1 and 2 make the entire size so large as to inconvenience handling.

On the other hand, for the purpose of obtaining an optical amplifier smaller than the conventional EDFA, for example, JP2001-189507A proposes an optical amplifier, characterized in that an optical waveguide consisting of a core doped with a rare earth element and a clad with a refractive index lower than that of the core is provided on a substrate, and that the one or more pumping light sources for exciting said rare earth element in the direction to cross the signal propagation direction in the core are provided adjacently to the optical waveguide on the substrate.

However, in the proposed optical amplifier, since the pumping light sources are point light sources, numerous pumping light sources are necessary for coupling with the core in the wide range of the optical wavelength, and the optical amplifier still has a problem that its size is large.

The object of this invention is to solve the above-mentioned problems of the prior art.

### SUMMARY OF THE INVENTION

To solve the above-mentioned problems, this invention proposes, as claim 1, a waveguide optical amplifier, characterized in that a surface light emission source for pumping driven electrically is provided adjacently to and integrally with an optical waveguide doped with a light-emitting species, in the longitudinal direction of the optical waveguide.

This invention proposes, as claim 2, that the light-emitting species is a rare earth element.

This invention proposes, as claim 3, that the light-emitting species is erbium.

This invention proposes, as claim 4, a waveguide optical amplifier, in which the surface light emission source for pumping is installed at least on one side of the optical waveguide.

This invention proposes, as claim 5, a waveguide optical amplifier, in which plural surface light emission source for pumpings are installed around the optical waveguide.

This invention proposes, as claim 6, a waveguide optical amplifier, in which the optical waveguide is a planar optical waveguide.

This invention proposes, as claim 7, a waveguide optical amplifier, in which the optical waveguide is an optical fiber.

This invention proposes, as claim 8, a waveguide optical amplifier, in which plural integral sets, each consisting of an optical waveguide and a surface light emission source for pumping, are arrayed on a substrate.

This invention proposes, as claim 9, a waveguide optical amplifier, in which plural optical waveguides are arrayed on a substrate, integrally together with a common surface light emission source.

This invention proposes, as claim 10, a waveguide optical amplifier, in which the material of the optical waveguide(s) is silica-based inorganic glass.

This invention proposes, as claim 11, a waveguide optical amplifier, in which the material of the optical waveguide(s) is multicomponent oxide glass.

This invention proposes, as claim 12, a waveguide optical amplifier, in which the material of the optical waveguide(s) is inorganic fluoride glass.

This invention proposes, as claim 13, a waveguide optical amplifier, in which the material of the optical waveguide(s) is an organic polymer.

This invention proposes, as claim 14, a waveguide optical amplifier, in which the surface light emission source for pumping is an electroluminescent light source.

This invention proposes, as claim 15, a waveguide optical amplifier, in which the electroluminescent light source is an inorganic electroluminescent light source.

This invention proposes, as claim 16, a waveguide optical amplifier, in which the light-emitting species of the inorganic electroluminescent light source is ytterbium (Yb).

This invention proposes, as claim 17, a waveguide optical amplifier, in which the inorganic electroluminescent light source contains neodymium (Nd) as a sensitizer.

According to this invention as described above, since the surface light emission source for pumping integral with the optical waveguide(s) emits light from the entire surface thereof in the longitudinal direction, the light can be highly efficiently coupled with the optical waveguide, to highly efficiently pump the light-emitting species in the optical waveguide(s), for allowing optical signal amplification.

Furthermore, the surface light emission source for pumping can emit light when a voltage is applied between its predetermined electrodes. Since no external light source is necessary, handling is very easy.

As the light-emitting species to be doped in the optical waveguide, erbium can be used as in the above-mentioned conventional erbium-doped fiber amplifier, and another rare earth element can also be used.

As for the constitution of the optical amplifier, the surface light emission source for pumping can be installed at least on one side of the optical waveguide, or plural surface light emission sources for pumping can also be installed around the optical waveguide.

As for the constitution of the optical amplifier, the optical waveguide can be a planar optical waveguide or an optical fiber.

Furthermore, the optical amplifier of this invention can also have plural identical components arrayed. In this case, plural integral sets, each consisting of an optical waveguide and a surface light emission source for pumping, can be arrayed on a substrate, or plural optical waveguides can be arrayed on a substrate, integrally together with a common surface light emission source.

As the material of the optical waveguide used in the optical amplifier of this invention, any conventional adequate material can be used. That is, silica-based inorganic glass, multicomponent oxide glass, inorganic fluoride glass or organic polymer can be used as the material of the optical waveguide.

As the surface light emission source for pumping, for example, an electroluminescent light source can be used. Therefore, the light emission source can be thinner, allowing the optical amplifier as a whole to be kept very small, and a highly integrated package can also be formed easily.

The electroluminescent light source can be either an organic electroluminescent light source or an inorganic electroluminescent light source. As the light-emitting species of the inorganic electroluminescent light source, for example, ytterbium (Yb) can be used.

The inorganic electroluminescent light source can also contain neodymium (Nd) as a sensitizer.

### BRIEF DESCRIPTION OF THE DRAWINGS

The numerous objects and advantages of the present invention may be better understood by those skilled in the art by reference to the accompanying drawings, in which:

FIG. 1 is a longitudinal sectional view conceptually and typically showing the waveguide optical amplifier of this invention.

FIG. 2 is a perspective sectional view conceptually and typically showing the waveguide optical amplifier of this invention.

FIG. 3 is a cross sectional view conceptually and typically showing an essential portion of the waveguide optical amplifier of this invention.

FIG. 4 are cross sectional views conceptually and typically showing essential portions of other examples of the waveguide optical amplifier of this invention.

FIG. 5 is a perspective cross sectional view conceptually and typically showing an essential portion a further other example of the waveguide optical amplifier of this invention, having plural optical waveguides arrayed.

FIG. 6 is a perspective sectional view conceptually and typically showing a further other example of the waveguide optical amplifier of this invention.

FIG. 7 is a perspective sectional view conceptually and typically showing an essential portion of an example having the waveguide optical amplifiers of this invention arrayed.

FIG. 8 is a graph showing an example of the gain characteristic of the waveguide optical amplifier of this invention.

FIG. 9 is a graph showing another example of the gain characteristic of the waveguide optical amplifier of this invention.

FIG. 10 is a conceptual view showing the constitution of a conventional EDFA.

### DETAILED DESCRIPTION OF THE PREFERRED EMBODIMENT

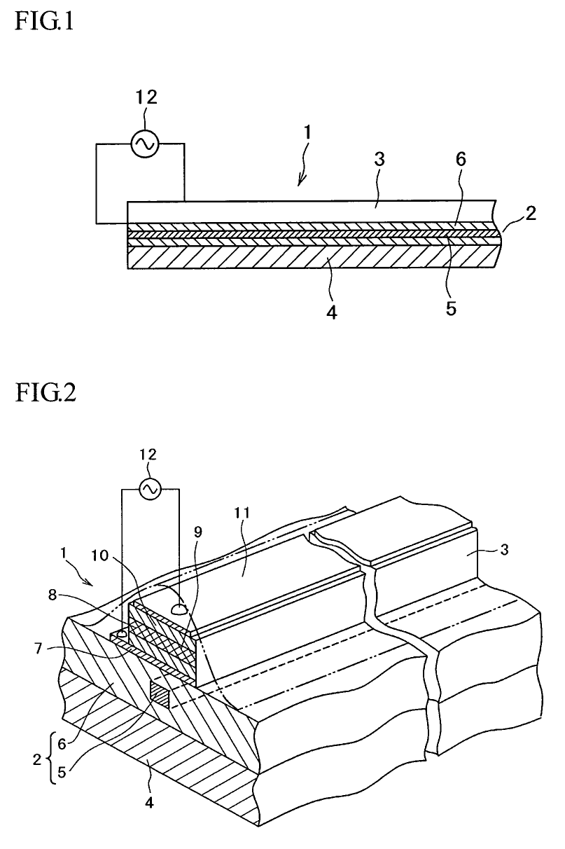

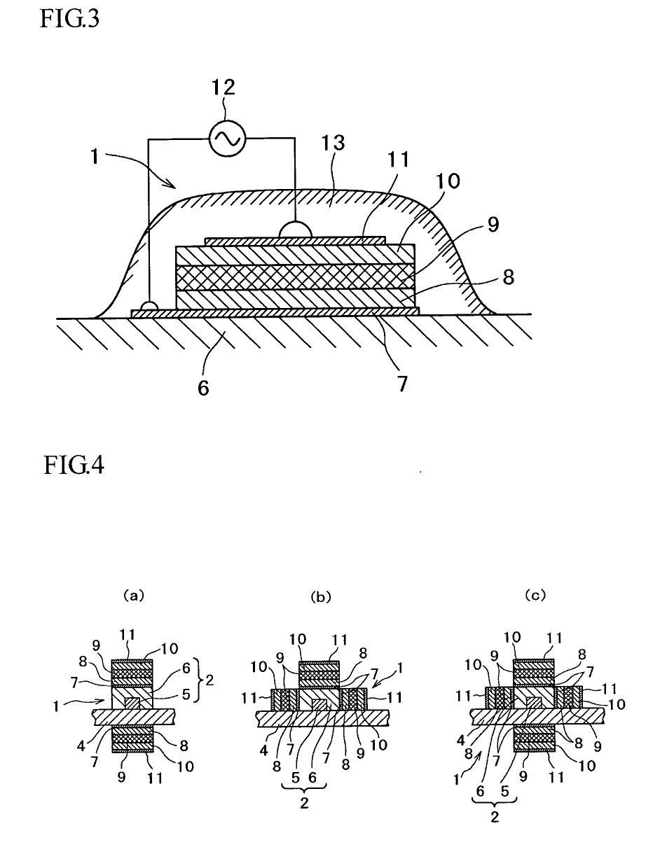

FIGS. 1 to 3 are typical views showing conceptually the waveguide optical amplifier of this invention. FIG. 1 is a longitudinal sectional view. FIG. 2 is a perspective sectional view. FIG. 3 is a cross sectional view of an important portion.

As shown in these drawings, in the waveguide optical amplifier 1 of this invention, a surface light emission source 3 for pumping driven electrically is provided adjacently to and integrally with an optical waveguide 2 doped with a rare earth element such as erbium as a light-emitting species, in the longitudinal direction of the optical waveguide.

Symbol 4 denotes a substrate, and the optical waveguide 2 and the surface light emission source for pumping 3 are arrayed on the substrate 4, to constitute the waveguide optical amplifier 1.

The substrate 4 is made of, for example, silica-based glass.

On the other hand, the optical waveguide 2 consists of a core 5 and a clad 6, and can be produced using the conventional technique for producing an erbium-doped optical fiber or the like.

The core has, for example, the following composition, and is produced according to a CVD method.
SiO₂—Al₂O₃—GeO₂—ErO₃(—Yb₂O₃)
(SiCl₄) (AlCl₃)(GeCl₄) (ErCl₃ or Er FOD)

In this case, in reference to the amount of Al₂O₃, type I of Al₂O₃<2 wt % and type II of 2 wt %<Al₂O₃<4.5 wt % are prepared.

The core width (diameter) is, for example, 5 to 8 μm. The clad is made of SiO₂ and has a thickness of up to about 100 μm.

As the surface light emission source for pumping 3, an electroluminescent light source is used, and has a transparent electrode 7, a dielectric layer 8, a Yb-doped light-emitting layer 9, a dielectric layer 10 and a metallic electrode 11 laminated in this order from the optical waveguide 2 side. These layers are formed, for example, by sputtering the following materials for vapor deposition. Furthermore, a power source is connected between the transparent electrode 7 and the metallic electrode 11, and the electroluminescent light source consisting of the respective layers is covered with a plastic material 13.

The respective components are composed, for example, as follows.
Transparent electrode 7: ITO (Indium Tin Oxide)
Dielectric layers 8 and 10: Y₂O₃, Al₂O₃, Ta₂O₅, thickness 100 to 500 nm
Yb-doped light-emitting layer 9: Thickness 200 to 500 nm
   Parent phase: ZnS, Y₂O₃, ZnGa₂O₄, Ga₂O₃, CaS, SrS, BaAl₂S₄, CaGa₂S₄, SrGa₂S₄, etc.
   Yb content: 0.5, or selected from 1.0 to 20 (%)
Metallic electrode 11: Al, etc.
Covering plastic material 13: An adequate plastic material
Power source 12: Sinusoidal wave or rectangular wave of 0.5 to 5 kHz

In the above constitution, the voltage applied from the power source 12 between the transparent electrode 7 and the metallic electrode 11 forms a potential gradient that causes the Yb-doped light-emitting layer 9 to emit light. The light is transmitted through the transparent electrode 7 and coupled with the optical waveguide 2, to pump the light-emitting species, i.e., erbium doped in the core 5 of the optical waveguide 2, for allowing optical signal amplification.

Since the surface light emission source for pumping 3 is integral with the optical waveguide 2 like this and emits light from the entire surface thereof in the longitudinal direction of the waveguide 2, the light can be highly efficiently coupled with the optical waveguide 2, to highly efficiently pump the light-emitting species in the optical waveguide 2, for allowing optical signal amplification.

The surface light emission source for pumping 3 can emit light when a voltage is applied between the transparent electrode 7 and the metallic electrode 11. So, since no external light source is necessary, handling is very easy.

To highly efficiently excite the light-emitting species in the optical waveguide 2 as described above, the luminance of the surface light emission source for pumping 3 must be higher than a certain level, for example, up to about 100 lm/W. For example, in the case where an inorganic electroluminescent light source doped with ytterbium (Yb) as a light-emitting species is used, the necessary luminance can be obtained, since the light emission efficiency of ytterbium per se is high, and since the ytterbium content can be enhanced using the nature that the light emission efficiency does not decline even at a higher ytterbium content. Furthermore, it is also effective to let the inorganic electroluminescent light source contain neodymium (Nd) as a sensitizer.

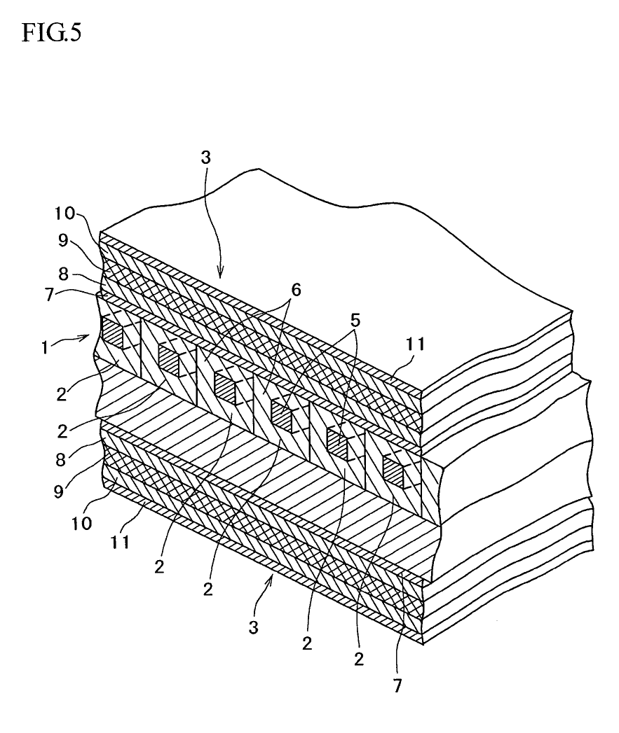

FIG. 4 show other examples of the waveguide optical amplifier 1 of this invention.

In these examples, since the respective components are identical with those of FIGS. 1 to 3, the corresponding components are given the same symbols, to avoid double explanation.

In FIG. 4(a), another surface light emission source for pumping 3 is installed also on the back side of the substrate 4 in addition to the constitution of FIGS. 1 to 3, to allow optical coupling with the optical waveguide 2 from top and bottom sides.

In FIG. 4(b), other surface light emission source for pumpings 3 are installed also on the right and left sides of the optical waveguide 2 in addition to the constitution of FIGS. 1 to 3, to allow optical coupling with the optical waveguide 2 from top, right and left sides.

In FIG. 4(c), a further other surface light emission source for pumping 3 is installed also on the back side of the substrate 4 in addition to the constitution of (b), to allow light coupling with the optical waveguide 2 from four sides.

If surface light emission sources for pumping 3 are installed on the respective sides of the optical waveguide 2 as shown in the respective examples of FIG. 4, to increase the quantity of light coupled with the optical waveguide 2, the light-emitting species in the optical waveguide 2 can be more highly efficiently excited to allow optical signal amplification.

FIG. 5 shows an example of the optical amplifier of this invention, in which plural identical components are arrayed. Since the respective components are identical with those of FIGS. 1 to 4, the corresponding components are given the same symbols, to avoid double explanation.

In this example, plural optical waveguides 2 are arrayed on the substrate 4, integrally together with common surface light emission source for pumping. In FIG. 5, the surface light emission source for pumpings 3 are installed on both sides of the substrate 4 like the constitution shown in FIG. 4(a), but one surface light emission source 3 for pumping can also be installed on one side only as shown in FIGS. 1 to 3.

As for the mode of array, in addition to the mode shown in FIG. 5, plural integral sets, each consisting of an optical waveguide 2 and a surface light emission source 3 for pumping, can also be arrayed on the substrate 4.

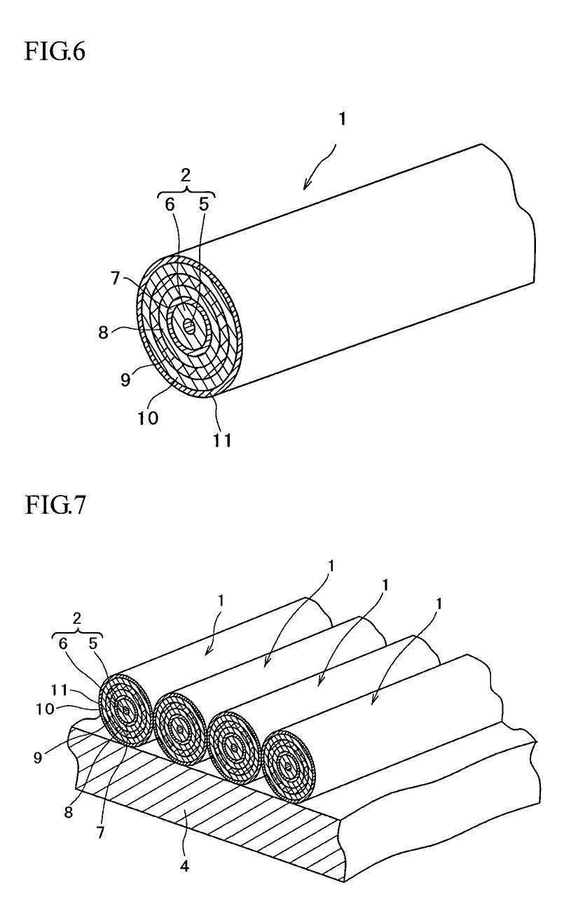

In the modes shown in FIGS. 1 to 5, each optical waveguide 2 is a planar optical waveguide, but in the mode shown in FIG. 6, the optical waveguide 2 is an optical fiber, and a light emission source 3 for pumping is provided concentrically around the clad 6 of the optical waveguide 2. The respective components of the surface light emission source 3 for pumping are identical with those of the constitution shown in FIGS. 1 to 5, except that they are concentric with the optical waveguide 2, having a transparent electrode 7, a dielectric layer 8, a Yb-doped light-emitting layer 9, a dielectric layer 10 and a metallic electrode 11 laminated in this order outwardly from the clad 6 side.

FIG. 7 shows a constitution, in which waveguide optical amplifiers 1 like optical fibers constituted like this are arrayed on the substrate 4.

FIG. 8 shows the gain of the waveguide optical amplifier 1 of this invention vs. the erbium content in the core 5. In this case, the following conditions were employed.
Length of waveguide optical amplifier 1: 10 cm
Wavelength of pumping light: 980 nm
Intensity of pumping light: 120 mW
Signal wavelength: 1530 nm

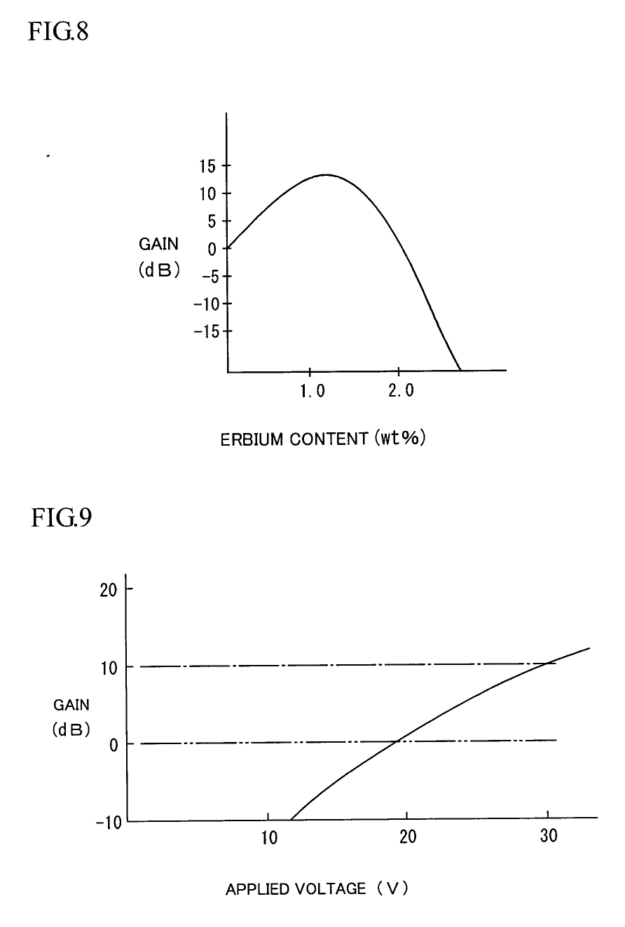

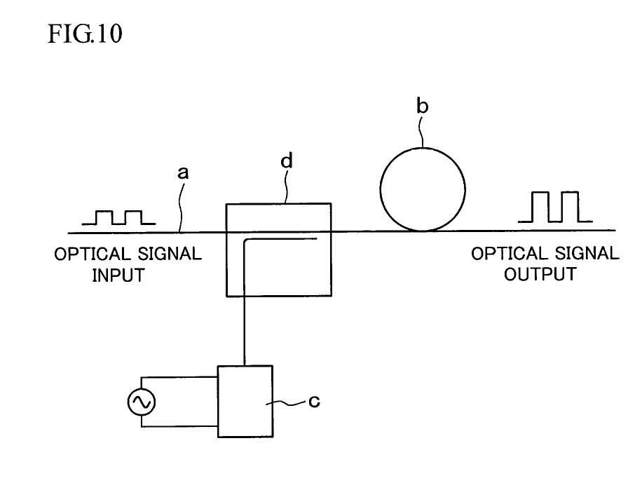

FIG. 9 shows the gain of the waveguide optical amplifier 1 of this invention vs. the applied voltage of the surface light emission source for pumpings 3 installed on both sides of the substrate 4. In this case, the following conditions were employed.
Length of waveguide optical amplifier 1: 10 cm
Wavelength of pumping light: 980 nm
Intensity of pumping light: 120 mW
Signal wavelength: 1530 nm
Erbium content: 1.2 wt %

### INDUSTRIAL APPLICABILITY

This invention gives the following features.
a. Since a surface light emission source for pumping is integrated with an optical waveguide doped with a light-emitting species such as erbium, to allow light emission on the entire surface thereof in the longitudinal direction of the optical waveguide, the light can be highly efficiently coupled with the optical waveguide, and as a result, the light-emitting species in the optical waveguide can be pumped highly efficiently to allow optical signal amplification.
b. The surface light emission source for pumping can be caused to emit light if a voltage is applied between its predetermined electrodes. So, since no external light source is necessary, handling is very easy.
c. The surface light emission source for pumping can be, for example, an electroluminescent light source. Therefore, the light emission source can be thinner, allowing the optical amplifier as a whole to be kept very small, and a highly integrated package can be formed easily.

1. A waveguide optical amplifier, characterized in that a surface light emission source for pumping driven electrically is provided adjacently to and integrally with an optical waveguide doped with a light-emitting species, in the longitudinal direction of the optical waveguide.

2. A waveguide optical amplifier, according to claim 1, wherein the light-emitting species is a rare earth element.

3. A waveguide optical amplifier, according to claim 2, wherein the light-emitting species is erbium.

4. A waveguide optical amplifier, according to claim 1, wherein the surface light emission source for pumping is installed at least on one side of the optical waveguide.

5. A waveguide optical amplifier, according to claim 1, wherein plural surface light emission sources for pumping are installed around the optical waveguide.

6. A waveguide optical amplifier, according to claim 1, wherein the optical waveguide is a planar optical waveguide.

7. A waveguide optical amplifier, according to claim 1, wherein the optical waveguide is an optical fiber.

8. A waveguide optical amplifier, according to claim 1, wherein plural integral sets, each consisting of an optical waveguide and a surface light emission source for pumping, are arrayed on a substrate.

9. A waveguide optical amplifier, according to claim 1, wherein plural optical waveguides are arrayed on a substrate, integrally together with a common surface light emission source for pumping.

10. A waveguide optical amplifier, according to claim 1, wherein the material of the optical waveguide(s) is silica-based inorganic glass.

11. A waveguide optical amplifier, according to claim 1, wherein the material of the optical waveguide(s) is multicomponent oxide glass.

12. A waveguide optical amplifier, according to claim 1, wherein the material of the optical waveguide(s) is inorganic fluoride glass.

13. A waveguide optical amplifier, according to claim 1, wherein the material of the optical waveguide(s) is an organic polymer.

14. A waveguide optical amplifier, according to claim 1, wherein the surface light emission source for pumping is an electroluminescent light source.

15. A waveguide optical amplifier, according to claim 14, wherein the electroluminescent light source is an inorganic electroluminescent light source.

16. A waveguide optical amplifier, according to claim 15, wherein the light-emitting species of the inorganic electroluminescent light source is ytterbium (Yb).

17. A waveguide optical amplifier, according to claim 15, wherein the inorganic electroluminescent light source contains neodymium (Nd) as a sensitizer.
